(19) United States
(12) Patent Application Publication
(10) Pub. No.: US 2014/0115042 A1
(43) Pub. Date: Apr. 24, 2014

(54) ONLINE Q&A METHOD, DEVICE, AND SYSTEM

(71) Applicant: Tencent Technology (Shenzhen) Company Limited, Shenzhen (CN)

(72) Inventor: BO YIN, Shenzhen (CN)

(73) Assignee: Tencent Technology (Shenzhen) Company Limited, Shenzhen (CN)

(21) Appl. No.: 14/142,901

(22) Filed: Dec. 29, 2013

Related U.S. Application Data
(63) Continuation of application No. PCT/CN2013/072985, filed on Mar. 21, 2013.

(30) Foreign Application Priority Data
Mar. 31, 2012 (CN) 201210095130.9

(51) Int. Cl. H04L 29/06

(52) U.S. Cl. CPC H04L 65/403
USPC 709/203

(57) ABSTRACT

Disclosed are an online Q&A method, device, and system. In an exemplary online Q&A method, a question request sent by a client terminal device can be received by a server. The question request can contain information about a question, an ID of a questioner user, and information about a location of the questioner user. Based on the information about the location of the questioner user and information about locations of other users, the server can determine other online users within a set distance range from the location of the questioner user. The server can then send the received information about the question to client terminal devices of the other online users within the set distance range from the location of the questioner user.

### CROSS-REFERENCES TO RELATED APPLICATIONS

This application is a continuation application of PCT Patent Application No. PCT/CN2013/072985, filed on Mar. 21, 2013, which claims priority to Chinese Patent Application No. CN201210095130.9, filed on Mar. 31, 2012, the entire contents of both of which are incorporated herein by reference.

### FIELD OF THE DISCLOSURE

The present disclosure relates to the field of communication technology and, more particularly, relates to a method, a device, and a system for online Q&A (question and answer).

### BACKGROUND

With the development of the Internet and communication technologies, the Internet access functionality has become very common in a mobile terminal such as a portable computer, a smart phone, and an IPAD. The Internet has also become an important part in daily life. Due to desire features such as timeliness and extensiveness of the Internet, more and more people tend to seek answers via the Internet for various problems encountered in daily life. It is therefore demanded to obtain quick and accurate information via the Internet, which has led to rapid development of online Q&A (question and answer) systems.

An online Q&A system is an application system that is commonly found in various websites such as social websites. A user asks a question, and other users may reply to the question when they see the question. In a current online Q&A system, every user can reply to a question when the user sees the question. With respect to a same question, all users (e.g., both questioner and answerers) may have differences in: understanding of the question, accuracy of information that each user possesses, living environments, etc. For example, a question is often asked involving the questioner's own information and own living environment. Information provided between the questioner and each answerer may not be matched with one another or having a low matching degree. In other words, answers may not be pertinent to the question and, many times, cannot be used by the questioner. Such undesired interactive communication processes, however, occupy bandwidth resources.

Therefore, there is a need to solve these and other problems and to provide desired online Q&A methods, devices, and systems.

### BRIEF SUMMARY OF THE DISCLOSURE

Online Q&A methods, devices, and systems are provided to solve problems that answers to a question are of low pertinence to the question, and to reduce waste of bandwidth resources.

According to various embodiments, there is provided an online Q&A method. In this method, a question request sent by a client terminal device can be received by a server. The question request can contain information about a question, an ID of a questioner user, and information about a location of the questioner user. Based on the information about the location of the questioner user and information about locations of other users, the server can determine other online users from the other users within a set distance range from the location of the questioner user. The server can then send the received information about the question to client terminal devices of the other online users within the set distance range from the location of the questioner user.

According to various embodiments, there is also provided a server used in an online Q&A system. The server can include a receiving module, a question processing module, and a sending module. The receiving module can be configured to receive a question request sent by a client terminal device, the question request containing information about a question, an ID of a questioner user, and information about a location of the questioner user. Based on the information about the location of the questioner user and information about locations of other users, the question processing module can be configured to determine other online users among the other users within a set distance range from the location of the questioner user. The question processing module can also be configured to instruct the sending module to send the information about the question to client terminal devices of the other online users that are within the set distance range from the location of the questioner user, such that the sending module sends the information about the question according to the instructing from the question processing module.

According to various embodiments, there is also provided a client terminal device used in an online Q&A system. The client terminal device can include a question module, a sending module, a receiving module, and a display module. The question module can be configured to generate a question request based on entered information about a question and obtained information about a location of a questioner user, the question request containing the information about the question, an ID of the questioner user, and the information about the location of the questioner user. The sending module can be configured to send the question request generated by the question module to a server. The receiving module can be configured to receive returned information of the question request from the server with respect to other users. Based on the information about the location of the questioner user and information about locations of other users, the server can determine other online users among the other users within a set distance range from the location of the questioner user; and send the received information about the question sent by the questioner user to client terminal devices of the other online users within the set distance range from the location of the questioner user. The display module can be configured to display the information received by the receiving module.

In an embodiment, when a server receives a question request sent by a client terminal device, based on information about a location of a questioner user and information about locations of other users, the server can determine other online users among the other users within a set distance range from the location of the questioner user and send information about a question contained in the question request to client terminal devices of the other online users. This can improve the pertinence of replies to the question and the effectiveness of the replies from the other online users to the questioner user, and can allow the questioner users to timely and accurately solve their problems.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIGS. 1A-1B are schematic diagrams illustrating an exemplary user registration process in accordance with various disclosed embodiments;

FIGS. 2A-2B are schematic diagrams illustrating an exemplary system login process in accordance with various disclosed embodiments;

FIGS. 3A-3B are schematic diagrams illustrating an exemplary user questioning process in accordance with various disclosed embodiments;

FIGS. 4A-4B are schematic diagrams illustrating an exemplary user reply process in accordance with various disclosed embodiments;

FIG. 5 is a schematic diagram illustrating an exemplary question query process for other's questions in accordance with various disclosed embodiments;

FIGS. 6A-6B are schematic diagrams illustrating an exemplary question refreshing process for other's questions in accordance with various disclosed embodiments;

FIG. 7 is a schematic diagram illustrating an exemplary question refreshing process for an own question in accordance with various disclosed embodiments;

FIG. 8 is a schematic structural diagram illustrating an exemplary server in accordance with various disclosed embodiments;

FIG. 9 is a schematic structural diagram illustrating an exemplary client terminal device in accordance with various disclosed embodiments; and

FIG. 10 is a schematic structural diagram illustrating an exemplary online Q&A system in accordance with various disclosed embodiments; and

FIG. 11 depicts a block diagram of an exemplary computing system consistent with the disclosed embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

Online Q&A systems are desired for a questioner user (e.g., a user who asks a question) to timely and accurately obtain answers from someone nearby (or within a certain distance range) and/or someone who is in a similar subjective or objective environment. A user who replies to the question may be referred to as “an answerer user” or “an answerer”. As disclosed herein, an online Q&A system is provided using an architecture including, e.g., client/server and/or browser/server. For example, the online Q&A system can include a client terminal (or a client terminal device) and a server. The client terminal and the server can use UDP (i.e., user datagram protocol) for data communication there-between.

For example, a client terminal can be used to initiate a question. Alternatively, a client terminal can be used to initiate a reply to a question which is initiated by another client terminal. A client terminal may be a mobile terminal or a PC (i.e., personal computer). Based on geographical location information of a client terminal of a questioner (e.g., having a questioner client terminal), the server can be used to send a question from the questioner client terminal to other online client terminals that are within a set or pre-set range to allow the other online client terminals to reply to the question.

As disclosed herein, geographical location information includes latitude and longitude coordinates. When a client terminal of a questioner user is a mobile terminal, a GPS (i.e., global positioning system) module of the mobile terminal can be used to obtain GPS information of the mobile terminal. When the client terminal of the questioner user is a PC, since the PC may not be provided with a GPS module, the PC client terminal can install a third-party application software to obtain simulated GPS information to include, e.g., latitude and longitude coordinates.

In one embodiment, both the client terminal and the server can use a Qt development framework for application development. As used herein, a Qt development framework is a cross-platform C++ application development framework. Software developed by using Qt development framework can be compiled and run on any supported platform with no need to modify the source code of the software.

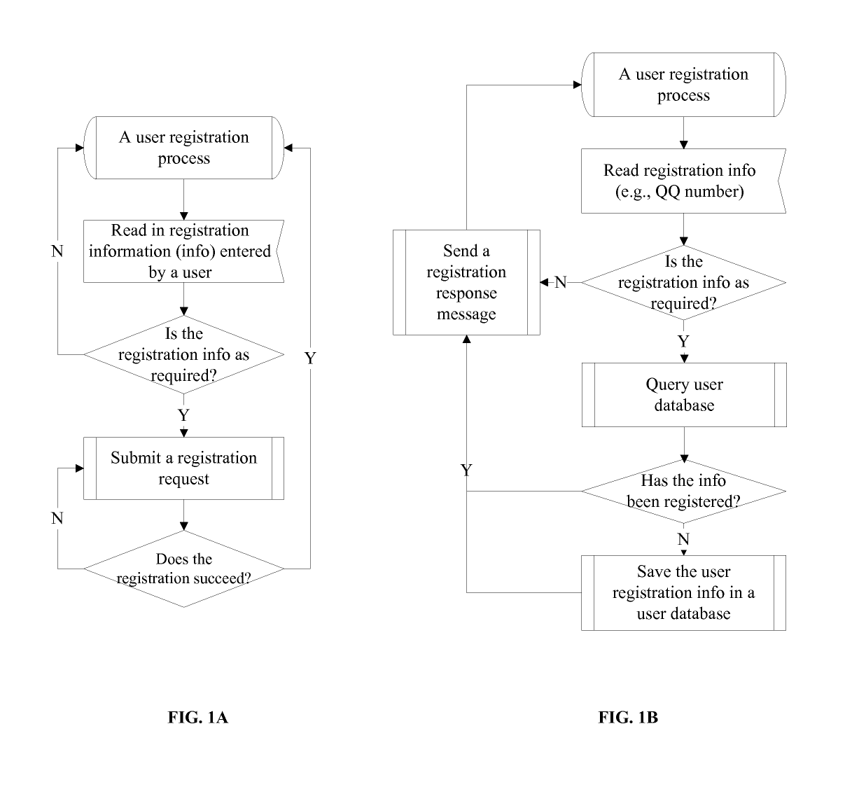

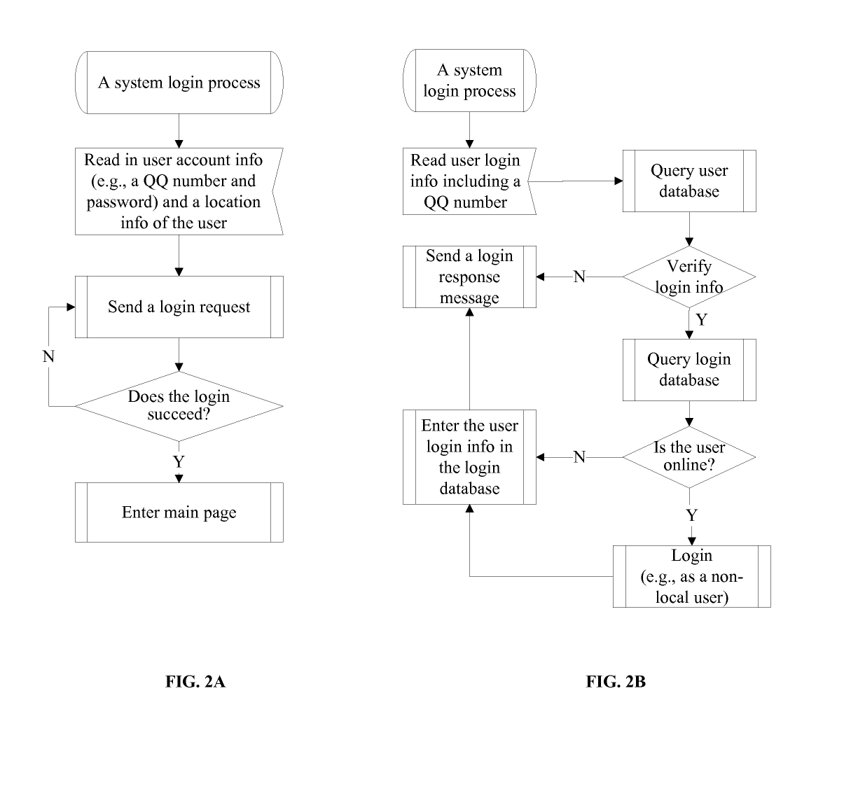

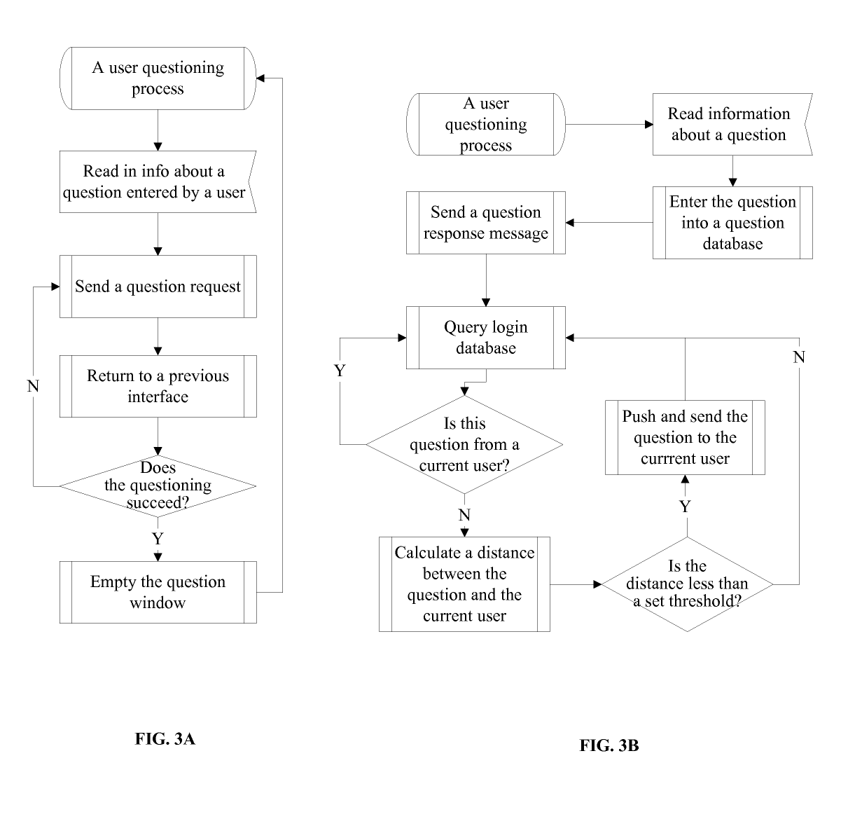

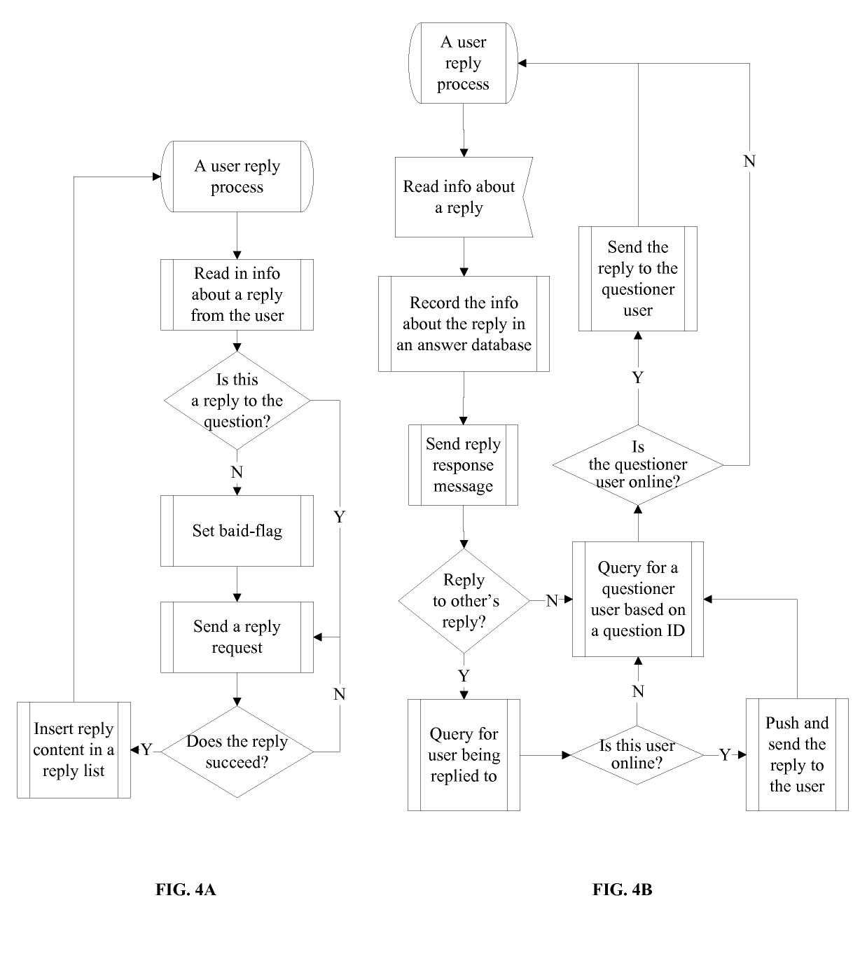

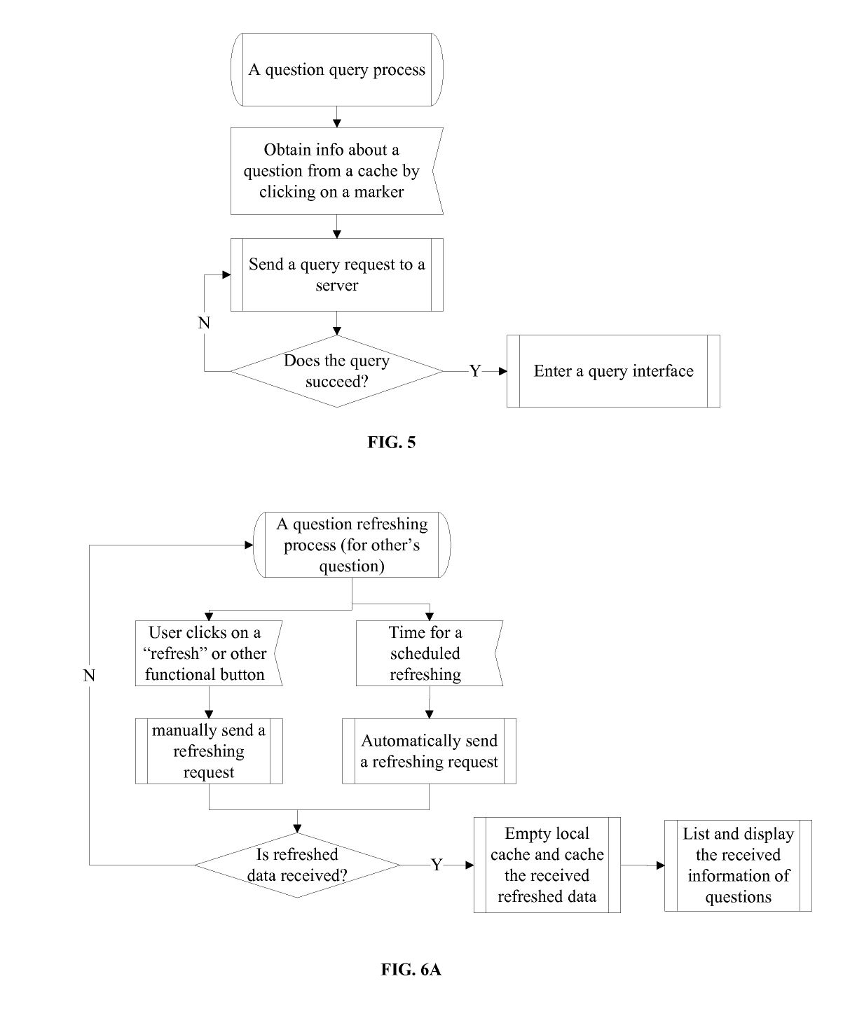

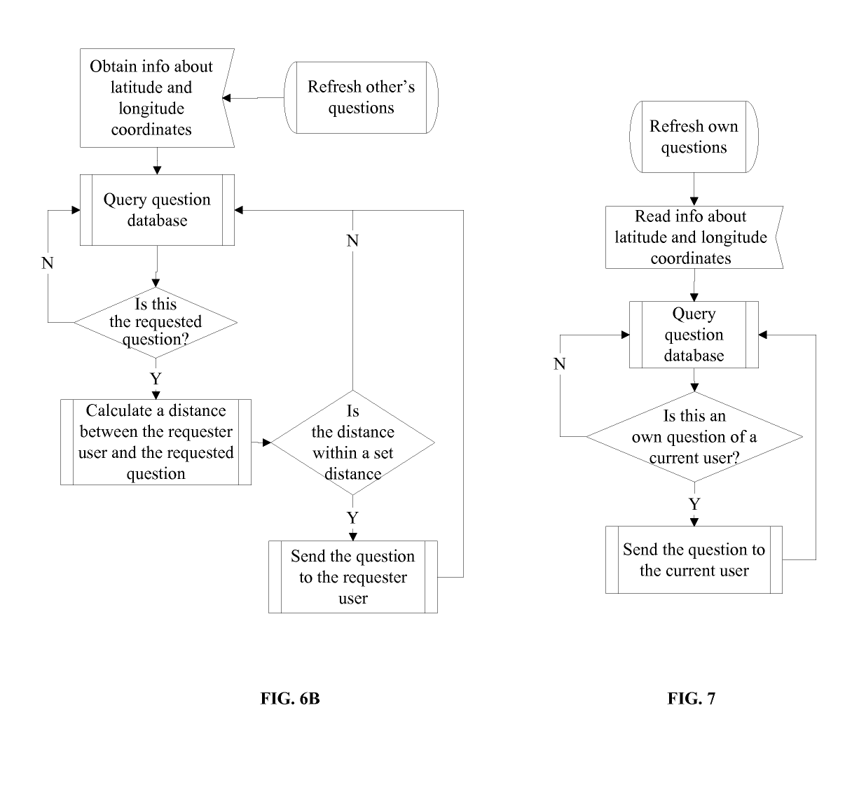

In one embodiment, the disclosed online Q&A system may be used by a user of a client terminal using operation processes including, for example, a user registration and/or cancellation process (e.g., as shown FIGS. 1A-1B), a system login process (e.g., as shown FIGS. 2A-2B), a questioning process (e.g., as shown FIGS. 3A-3B), a reply process (e.g., as shown FIGS. 4A-4B), a query process (e.g., as shown FIG. 5), and/or a refreshing process (e.g., as shown FIGS. 6A-6B and FIG. 7).

FIGS. 1A-1B depict an exemplary user registration and/or cancellation process. The exemplary process can include a client-terminal-side processing as shown in FIG. 1A, and a server-side processing as shown in FIG. 1B.

In an exemplary client-terminal-side processing for the user registration process as shown in FIG. 1A, a user can use a client terminal to read in registration information entered by the user and to submit a registration request to the online Q&A system. The registration information can include a unique user ID (e.g., an instant messaging number such as a QQ number), a nickname, a password, and/or other user information (e.g., a name, gender, and the like). The online Q&A system can provide a user registration interface displayed on the client terminal. If the registration information provides required information, the user can submit the registration request, e.g., using the user registration interface. If the registration information does not provide required information, another user registration process may be performed. In some cases, if the registration is not decided to be a success, another registration request may be submitted. In other cases, if the registration is decided to be a success, another registration request may be submitted as desired, as shown in FIG. 1A.

In an exemplary server side processing for the user registration process as shown in FIG. 1B, after receiving the registration request, the server can read the user registration information (e.g., including a QQ number); perform verification (e.g., if the registration information provides required information); and process the registration after the verification passes or is successfully confirmed. The user registration process can include, for example, saving the user registration information to a user database, which is a database for registered users, and returning a registration success message to the client terminal. The verification if the registration information provides required information may include, for example, checking whether the registration information is entered in a format that meets certain requirements and/or whether an entered instant messaging number (e.g., a QQ number) is a number new to the user database or already in the user database (e.g., registered by other people). When the registration information is entered in a format that meets the requirements and the instant messaging number is new or not already in the user database, the verification successfully passes. The user registration information can be saved to the user database. In some cases if the instant messaging number is already in the user database, a registration response message can be sent to the client terminal and another user registration process may be performed.

In various embodiments, for a registered user of the online Q&A system, the registered user can initiate a user cancellation process to cancel the user registration. Specifically, the user can use a user cancellation interface provided on the client terminal to submit a cancellation request to the server. After receiving the cancellation request from the user, the server can remove the registration information of the user from the user database.

Before a user of the online Q&A system performs online Q&A operations, the user may need to log into the system. FIGS. 2A-2B depict a user login process. The exemplary user login process can include a client-terminal-side processing as shown in FIG. 2A, and a server-side processing as shown in FIG. 2B.

In the exemplary client-terminal-side processing for the user login process as shown in FIG. 2A, the user can use a user login interface provided on the client terminal to enter user account (or login) information (e.g., an instant messaging number and/or a login password) and to submit a login request to the server. In addition to the user account information, the login request can also include information about a location of the user. Specifically, upon receiving a login command submitted by the user, the client terminal device may obtain GPS information via a GPS module or obtain simulated GPS information by triggering a third party software. Once the login process is successfully performed, a main page can be entered for various operations, e.g., for sending a question refreshing request as depicted in FIGS. 6A-6B. In some cases, if the login is not successfully performed, another login request can be submitted until a successful login process is performed, as shown in FIG. 2A.

In the exemplary server-side processing for the user login process as shown in FIG. 2B, after receiving the login request (e.g., having the user login information been read), the server can query user database and/or perform a verification to verify the login information. Once the verification successfully passes, the server can perform the login process, which includes recording the user ID and the user location information by querying a login user database (referred to as the login database). The login database can record information about IDs and locations of currently online users. When a user logs out or is offline for any reasons, the information about the user can be deleted from the login database. When performing verification, by querying in the user database, the server can determine whether the account information sent by the user is consistent with corresponding registration information of the user in the user database. If consistent information is found, the verification successfully passes. Further, after the verification of the account (or login) information successfully passes, the server can query the login database. When the user information is decided to be already in the login database, e.g., the user is already online, the system may mark the user as having logged in from a different location, e.g., as a non-local user and then inform the corresponding client terminal.

In addition, after the server has verified the account information of the client terminal, the server, based on the location of the login user, may push and send questions, asked by other users within a certain distance range from the login user, to the client terminal of the login user (e.g., such process may be similar to a corresponding process of a questioning process of a user to be described below). After receiving information pushed and sent by the server, the client terminal of the login user can display locations of the other users and their questions on an electronic map interface of the client terminal.

On the electronic map interface, a marker (e.g., location marker such a location icon) can be used to mark a user's location. When a first user clicks on a marker, a question asked by a corresponding user (e.g., a second user) can be displayed. When a plurality of users are located within a small distance range (for example, having a radius of about 10 meters), due to map precision limitation, the markers displayed on the map may substantially overlap with each other so that the user cannot click a marker at an underlying layer. In this case, the client terminal device of the user may display to the user the questions of the plurality of the users in this region in a form of listing the questions. The listing of the questions may include information about contents of the questions and times when the questions have been asked.

After a user logs in to the system, the user may ask a question. FIGS. 3A-3B depict an exemplary user questioning process. The exemplary user questioning process can include a client-terminal-side processing as shown in FIG. 3A, and a server-side processing as shown in FIG. 3B.

In the exemplary client-terminal-side processing for the user questioning process as shown in FIG. 3A, a user can use a client terminal to send a question request. Specifically, the user may enter information (e.g., question content) about a question on a question interface of the client terminal. The user may also select a type or a category for the questions. In one embodiment, the content of the question may be limited to include a certain number of words or characters, for example, within about 70 Chinese characters for asking a question. A question request that a user (which is referred to herein as a questioner user) submits can include information about the question (e.g., including content and ID), an ID of the questioner user (such as an instant messaging number), and/or location information of the questioner user. For a questioner user using a mobile terminal, the questioner user may have a login location different from a question location if the mobile terminal/user moves from one place to another. Therefore, after receiving a command to submit a question from the questioner user, the server may obtain location information of the client terminal via a GPS module. In one embodiment, the questioner user may return to a previous interface after the question request is sent. If such questioning is decided to be a success, the question window (or interface) may then be emptied. Otherwise if the questioning is not decided to be a success, another question request can be sent to ask questions, as shown in FIG. 3A.

In the exemplary server-side processing for the user questioning process, after receiving the question request (e.g., after information about the question is read and entered into a question database), the server can determine, based on the location information of the questioner user and location information of other users, other online users among the other uses within a pre-set or set distance range from the location of the questioner user can be determined.

For example, the server may query the login database to obtain information about locations of other users, and then respectively calculate distances, e.g., earth-spherical distances, between the questioner user and other users. Other online users who are located at a distance less than a set threshold can be determined among the other users. For example, the location of the questioner user can be used as a center point for the server to query for other users who are located within a radius of about 500 meters. After receiving the question request, the server can also assign a unique ID to the question and record the question ID, the question content, and the ID of the questioner user in a question database. Further, after receiving the question request, when the server finds that the location of the questioner user has changed (e.g., when using a mobile terminal), the server can update or refresh the information about the location of the questioner user in the login database.

In addition, the server can push and send the received information about the question to client terminals of the other online users. Since these other online users are located within a certain distance range from the questioner user, replies from these other online users can be pertinent to the question asked by the questioner user.

For example, as shown in FIG. 3B, after information about the question is read and entered into a question database, the server can send a question response message to the client terminal of the questioner user. The server can then query the login database and decide if the question is from a current user in the system. If the question is decided to be from the questioner user, another query process can be performed. If the question is not decided to be from the questioner user (i.e., from other users in the system), the distance between the question (or the questioner user) and the current user (i.e., one of the other users) may then be calculated as described above. Once the calculated distance is decided to be less than the set threshold, information about the question may be pushed and sent to the current user, i.e., one of the other online users. If the calculated distance is not less than the set threshold, another query process can be performed to query the login database, as shown in FIG. 4B.

A user may reply to questions asked by the other users (referred to as questioner users). FIGS. 4A-4B depict a user reply process. The exemplary user reply process can include a client-terminal-side processing as shown in FIG. 4A, and a server-side processing as shown in FIG. 4B. In one example, an answerer user C may reply to question 1 asked by a questioner user A.

In the exemplary client-terminal-side processing for the user reply process, the exemplary answerer user C can use a client terminal to select a question (e.g., question 1) from the exemplary questioner user A; enter information to reply to the question; and send a reply request to the server. The reply request can include the ID of the answerer user C, the ID of information about the question and content of the reply. Specifically, the answerer user can use a reply operation interface provided by the client terminal to select a question that needs a reply. The answerer user can baid-flag the question; enter reply content to the question; and send out a reply request.

For example, as shown in FIG. 4A, the terminal device of a user can read in information about a reply entered by the user and then decide if this reply is the reply to the question. If the reply is decided to be for the question, the reply request can be sent out. If a reply is not decided to be for the question, the question can be baid-flagged and then a reply request can be sent out. Once the reply is decided to be successful, the reply content can be inserted into a reply list corresponding to the question. If the reply is not decided to be successful, another reply request may be sent out.

In the server-side processing for the user reply process, after receiving the reply request, the server can query for the questioner user A based on the question 1, and send the reply content to the client terminal of the questioner user A. Specifically, after receiving the reply request, the server can assign a reply ID to the reply content and record in a reply database (or answer database) information about the reply including: the reply ID, the reply content, and/or the question ID (e.g., the question 1) that the reply content is directed to. Based on the question ID (e.g., for the question 1) contained in the reply request, the server can query the question database for the questioner user ID (e.g., for the questioner user A) corresponding to the question being replied, and then send the reply content back to the client terminal of the questioner user ID (e.g., the questioner user A).

In addition, the client terminal can display the reply content after the reply content from the server is received. Specifically, after receiving the reply content, the client terminal of the questioner user A can insert the reply content to a reply list of the corresponding question and display the reply content.

Further, if another user B (e.g., an answerer user B) has already replied to the question 1 asked by the questioner user A, the server may also send the reply content of the answerer user C to the answerer user B. In one embodiment, after receiving the reply request, the server can obtain the question ID of the question 1 contained in the reply request. Based on the ID of the question 1, the server can query the answer database for all user IDs (e.g., including the answerer user B) corresponding to the ID of the question 1, and send the reply content to the client terminals of these users that the server have found. In a specific embodiment, before sending the reply content to the client terminals of these users, the server may also query the login database for online status of these users so that the reply content can be send to client terminals of online users among these users.

For example, as shown in FIG. 4B, after receiving information about a reply, the server can record the information about the reply in an answer database and send out a reply response message. In some cases, the server may decide to reply to others' reply (e.g., the answerer user B's) and query for users (e.g., including the answerer user B) being replied to, based on the baid. If this user is online, the reply may be pushed and sent to this user. If this user is not online, the server may query for the questioner user based on the question ID. On the other hand, if it is not decided to reply to the others' reply, the server may directly query for the questioner user based on the question ID. If this questioner user is online, then the reply can be sent to the questioner user. If this questioner user is not online, then another user reply process may be performed.

The disclosed online Q&A system also provides a function that allows a user to query for questions asked by other users. For example, FIG. 5 depicts an exemplary user query process. The exemplary user query process can be a process for a user to initiate and query other's questions (i.e., questions asked by others).

In a first step, a user can use a client terminal to send a query request to the server to request a query for questions asked by other users. The query request can contain an ID of the query requester user. Specifically, the user may use a query interface provided by the client terminal to submit the query request.

In a second step, after receiving the query request, the server can determine, based on the location information of the questioner user and information about locations of other users, other users who are online (i.e., other online users) and within a set distance range from the location of the questioner user. The server can then return questions asked by the other online users to the client terminal of the query requester user.

In one embodiment, after receiving the query request, the server can obtain the ID of the query requester user that is contained in the query request. Based on the query requester user ID, the server can query the login database for information about the location that the query requester user ID corresponds to. The server can then respectively calculate earth spherical distances between the query requester user and the other users and determine other online users located at distances less than a set threshold. For example, using the location of the questioner user as a center of a circle, the server can query for other online users located within a circle of a radius of about 500 meters, and obtain IDs of these online users. Then, based on these user IDs, the server can query the question database to obtain contents of questions asked by these users and return the questions asked by these users and information about the locations of these users to the client terminal of the query requester user.

In a third step, after receiving the query results returned from the server, the client terminal of the query requester user can display the queried results. For example, when a plurality of users are located within a small distance range (for example, a circular range of a radius of about 10 meters), the client terminal may display to the user the questions of the plurality of the users in this region in a form of listing the questions. The listing of the questions may include information about contents of the questions and/or times when the questions are asked.

For example, as shown in FIG. 5, in a question query process, information about a question can be obtained from a cache by clicking on a marker on the client terminal device by a user (e.g., a query requester user). A query request can then be sent to the server. If the query is decided to be a success, then a query interface is provided on the client terminal to provide a response to the query request including the queried results. If the query isn't decided to be a success, another query request can be sent for a question query process.

The disclosed online Q&A system also provides a function that allows questions asked by other users to be refreshed. FIGS. 6A-6B are schematic diagrams of a process for refreshing questions asked by other users in accordance with various disclosed embodiments. For example, such question refreshing process can be triggered via a manual mode or an automatic mode.

As shown in FIG. 6A, by the manual mode, a user can use a client terminal to send a refreshing request. By the automatic mode, when questions asked by other users cached by the client terminal have not been updated for a certain period of time (which is configurable), the client terminal can be scheduled to automatically initiate a refreshing request. Alternatively, other operations of a user such as clicking on a “refresh” button or other functional button such as a “home page” (e.g., an electronic map can be displayed on the home page, on which locations and questions asked by other users can be indicated) can manually initiate a refreshing request.

In other embodiments, the question refreshing process can be scheduled, e.g., every three or other certain minutes, to automatically send the refreshing request. Based on the refreshing request, the server can return questions, asked by other users within a certain distance range around the question refreshing requester user (or a request initiator user), to the client terminal of the question refreshing requester user.

The question refreshing process may include the following process. In a first step, the server can receive a refreshing request sent from (or sent by) a client terminal, the refreshing request including an ID of the question refreshing requester user. For example, the client terminal may initiate a refreshing request via the above-described manual mode or automatic mode.

In a second step, based on location information of the question refreshing requester user and information about locations of other online users, a distance between the question refreshing requester user and the requested question that is asked by others can be calculated. The server can determine other online users within a set distance range from the location of the question refreshing requester user. The server can query for information about questions sent by the other online users. In one embodiment, implementation of the present step (e.g., including the above described determining and querying steps) is the same as a corresponding step in the above user questioning process as depicted in FIG. 5. In some cases, if the distance between the question refreshing requester user and the requested question is not within the set distance, the server can query the question database until a distance there-between is found to be within the set distance, as shown in FIG. 6B.

In a third step, the server can return the information about the question sent by the other online users and information about locations of corresponding questioner users, that the server found, to the client terminal of the question refreshing requester user, as shown in FIG. 6B.

In a forth step, after receiving the refreshed results from the server, the client terminal of the question refreshing requester user can display the refreshed results. In one embodiment, a cache is provided in the client terminal for storing questions asked by other users (of course, may also include questions asked by the user-self) and location information. After receiving the refreshed results from the server, the client terminal of the question refreshing requester user can empty (e.g., delete information from) the local cache and then cache the received refreshed results (e.g., refreshed data). In some cases, if the refreshed data are not received, another refreshing operation can be performed as shown in FIG. 6A.

In a specific embodiment, the local cache may also store IDs of the questioner user and, accordingly, when performing the refreshing operation, the existing questioner IDs can be deleted from the local cache for the received questioner IDs can be cached. Based on the cached information, the client terminal can mark a location of a corresponding user on an electronic map interface, and further mark a question asked by the corresponding user or display the question asked by the corresponding user when the user clicks on the marker identifying the corresponding user on the electronic map. As described above, when a plurality of users are located within a small distance range (for example, a circular range of a radius of about 10 meters or other radius), the client terminal may display to the user the questions of the plurality of the users in this region in a form of listing of questions. The listing of the questions may include information about contents of the questions and/or times when the questions are asked.

In various embodiments, the client terminal may use an STL (i.e., standard template library) map container as a cache data structure to respectively store user's own questions and others' questions in the surrounding area of the current location. Similarly, the map container can be used to respectively map the GPS information of the questions of the other users in the surrounding area of a current location, and map the GPS information of the user's own questions, to the marker information on the map. For example, by reloading a “<” of the map container, the precision of the GPS information of the questions can be controlled to be within a range of 1E-4 (which corresponds to an earth surface distance of about 10 meters; a distance of about 10 meters on an electronic map at the maximum zoom-level is distinguishable and can be clicked by a user; therefore, questions within a distance of 10 meters are marked at a same point). The map container uses a red-black tree data structure, of which complexity of insertion and search algorithms is O(log(n)).

The disclosed online Q&A system also provides a user with a function that allows own questions to be refreshed. FIG. 7 depicts a process for a user to refresh own questions. For example, the user can use a client terminal to send a refreshing request to the server to request and to refresh own questions asked by the user (e.g., as a question refreshing requester user). The request can include the ID and/or information about location (e.g., latitude and longitude coordinates) of the user. After receiving the refreshing request, based on the user ID in the refreshing request, the server can query the question database for all question contents corresponding to the user ID and then return the found question contents to the client terminal of the question refreshing requester user for displaying. In some cases, if the question is not the question asked by the user (i.e., the current user or the question refreshing requester user), the server can query the question database again to obtain the question and return the found question to the client terminal of the current user, i.e., the question refreshing requester user, as shown in FIG. 7.

FIG. 8 depicts an exemplary server including, e.g., a receiving module 81, a question processing module 82, a sending module 83, a reply processing module 84, a first refreshing processing module 85, a second refreshing processing module 86, a login processing module 87, and/or a registration/cancellation processing module 88.

The receiving module 81 can be used to receive a question request sent from a client terminal device. The question request can include information about a question, an ID of a questioner user, and/or location information of the questioner user.

Based on the location information the questioner user and information about locations of other users, the question processing module 82 can be used to determine other online users within a set distance range from of the location of the questioner user, and instruct a sending module (e.g., the sending module 83) to send the information about the question to client terminal devices of the other online users within the set distance range from the location of the client terminal of the questioner user. Based on the question request, the question processing module 82 can also be used to record the information about the question including, e.g., content and ID of the question (e.g., which are included in the question request) and their corresponding relationship with the ID of the questioner user.

The sending module 83 can be used to send information about the question according to an instruction from the question processing module 82. In one embodiment, based on the ID of the questioner user and the location information of the questioner user that are included in the question request, the question processing module 82 can also be used to update the information about the location of the corresponding user that the question processing module 82 has recorded.

The receiving module 81 can also be used to receive a reply request from a client terminal device. The reply request can include information about a reply, information about an ID of the question to which the reply is directed, and an ID of an answerer user.

Based on information about the ID of the question, the reply processing module 84 can be used to query for an ID of a corresponding questioner user that has been recorded by the reply processing module 84, and to instruct the sending module to send the information about the reply to a corresponding client terminal device based on the queried ID of the questioner user. The sending module 83 can also be used to send information about a reply (or an answer) according to an instruction from the reply processing module 84.

In one embodiment, after receiving a reply request, the reply processing module 84 can also be used: to record information about content and ID of a reply, an ID of the question to which the reply is directed, and their corresponding relationship(s) with the ID of the questioner user; to query for, based on the ID of the corresponding question of the reply, IDs of other corresponding answerer users; and to instruct the sending module to send the information about the reply to corresponding client terminal devices based on the queried IDs of the answerer users.

The receiving module 81 can also be used to receive a refreshing request sent from a client terminal device. The refreshing request can include an ID of a refreshing requester user. The first refreshing processing module 85 can be used to determine, based on location information of the refreshing requester user and information about locations of other users, other online users within a set distance range from the location of the refreshing requester user. The first refreshing processing module 85 can be used to query for information about questions sent by the other online users; and to instruct the sending module to return the queried information about questions sent by the other online users and information about locations of the corresponding questioner users to the client terminal device of the refreshing requester user.

The server can also include a second refreshing processing module 86. After the receiving module 81 receives a request to refresh own questions asked by a user, the second refreshing processing module 86 can be used, based on a user ID contained in the request, to query the question database for all corresponding question contents of the user ID and return the queried question contents to the client terminal of the refreshing requester user for displaying.

The sending module 83 can be used to send information about a question and information about a location of a corresponding questioner user according to an instruction from the first refreshing processing module 85.

The receiving module 81 can be used to receive a login request sent from a client terminal. The login request can include information about a user account of a login user and information about a location of the login user. The login processing module 87 can be used, after verification with respect to the information about the user account of the login user is confirmed, to store the information about the location of the login user; to determine, based on the information about the location of the login user and information about locations of other users, other online users within a set distance range from the location of the login user; to query for information about questions sent by the other online users that has been recorded by the server; and to instruct the sending module to send the information about the questions sent by the other online users and the information about the locations of the corresponding questioner users to the client terminal device of the login user for displaying.

The sending module 83 can also be used to send information about a question and information about a location of a corresponding questioner user according to an instruction from the login processing module 87. After the receiving module 81 receives a registration request, the registration/cancellation processing module 88 can be used to read registration information, perform verification and, after the verification passes, store the registration information of the user to a (registration) user database. In some cases, after the receiving module 81 receives a cancellation request, the registration/cancellation processing module 88 can be used to delete the registration information of the user from the user database.

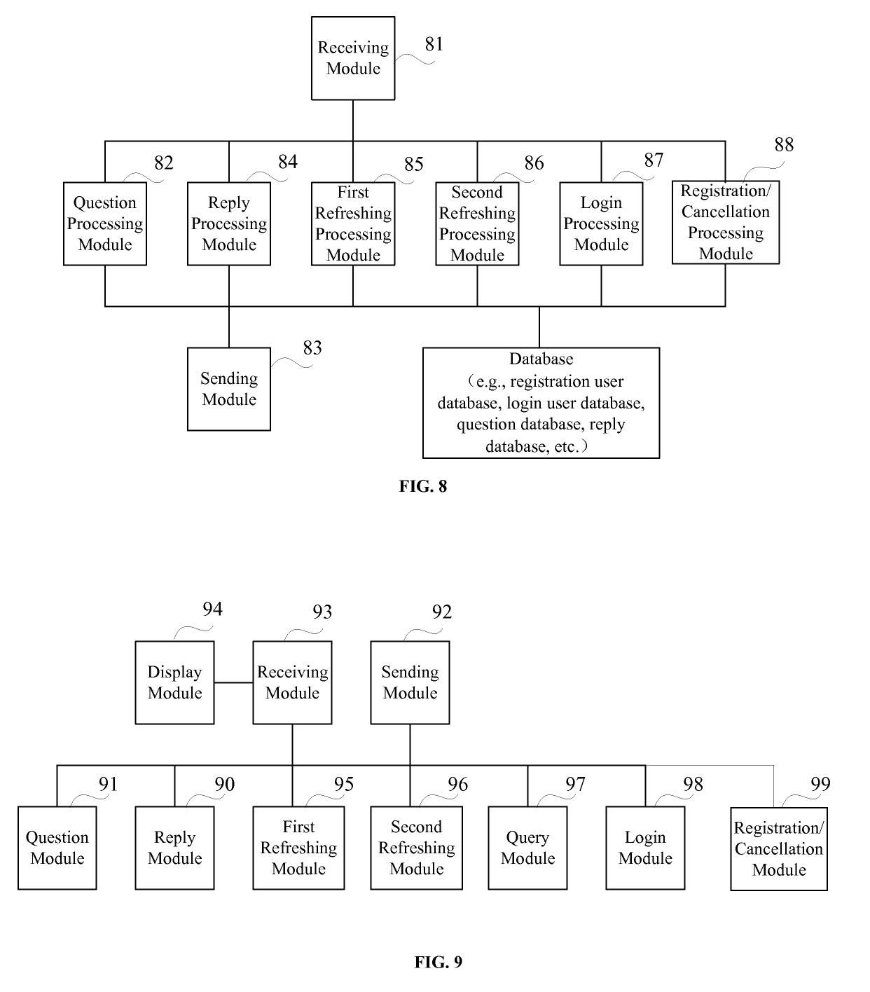

FIG. 9 depicts an exemplary client terminal device that can be used in an online Q&A system. The exemplary client terminal device can include a question module 91, a sending module 92, a receiving module 93, a display module 94, a first refreshing module 95, a second refreshing module 96, a query module 97, a login module 98, a registration/cancellation module 99, and/or a reply module 90.

The question module 91 can be used to generate a question request based on entered information about a question and obtained information about a location of a client terminal device related to the question. The question request can contain the information about the question, an ID of a questioner user, and the information about the location of the questioner user.

The sending module 92 can be used to send the question request generated by the question module 91 to the server. The receiving module 93 can be used to receive returned information of the question request from the server with respect to other users. Based on the information about the location of the questioner user and information about locations of other users, the server can determine or select other online users within a set distance range from the location of the questioner user and send the received information about the question sent from the questioner user to client terminal devices of the other online users within the set distance range from the location of the client terminal of the questioner user.

The display module 94 can be used to display information received by the receiving module 93. The client terminal can also include the first refreshing module 95 and a cache module (not shown).

The first refreshing module 95 can be used to send a refreshing request to the server. The refreshing request can contain an ID of a refreshing requester user. After receiving refreshed information returned from the server, the first refreshing module 95 can empty the cache module and store the refreshed information in the cache module. Based on the information about the location of the refreshing requester user and information about locations of other users, the server can select other online users within a set distance range from the location of the requester user and query for information about questions sent by the other online users, and return the queried information about the questions sent by the other online users and information about locations of corresponding questioner users to the client terminal device of the refreshing requester user. The cache module can be used to cache information about contents and IDs of questions, and information about locations of questioner users.

The display module 94 can be used to identify a location of each of the questioner users cached in the cache module on an electronic map by using a location marker. Based on a precision level of the location marker on the electronic map, the display module 94 can be used to generate a list of questions asked by questioner users that are distanced from each other within a precision range. The list can include the questions sent by the questioner users within the range of the precision. When a selection of a location marker by the user is received, the display module 94 can display the list of questions corresponding to the location marker.

The client terminal device can also include the second refreshing module 96, which can be used to send a refreshing request to the server via the sending module 92 to refresh own questions asked by the questioner user. The request can include an ID of the questioner user.

The client terminal device can also include the query module 97 and a cache module (not shown). The query module 97 can be used to send a query request to the server. The query request can include an ID of a query requester user. After receiving information about queried results returned from the server, the query module 97 can empty the cache module and store information about the queried results in the cache module. Based on information about a location of the query requester user and information about locations of other users, the server can determine other online users within a set distance range from the location of the requester user and query for information about questions sent by the other online users, and return the queried information about the questions sent by the other online users and information about locations of corresponding questioner users to the client terminal device of the query requester user. The cache module can be used to cache information about contents and IDs of information about questions, and information about locations of questioner users.

The display module 94 can be used to identify a location of each of the questioner users cached in the cache module on an electronic map by using a location marker. Based on the precision level of the location marker on the electronic map, the display module 94 can be used to generate a list of questions asked by questioner users, e.g., that are distanced from each other, within a precision range. The list can include the questions sent by the questioner users within the precision range. When a selection of a location marker by the user is received, the display module 94 can display the list of questions corresponding to the location marker.

The client terminal can also include the login module 98, which can be used to send a login request via the sending module 92 to the server. The login request can include information about a user account of a login user and information about a location of the login user. The login module 98 can also be used to receive information returned from the server. Based on the information about the location of the login user and information about locations of other users, the server can determine other online users within a set distance range from the location of the login user and query for information about questions sent by the determined other online users recorded by the server, and send the information about the questions asked by the other online users and information about locations of corresponding questioner users of the other online users to the client terminal device of the login user.

The display module 94 can be used to identify a location of each of the questioner users cached in the cache module on an electronic map by using a location marker. Based on the precision level of the location marker on the electronic map, the display module 94 can be used to generate a list of questions asked by questioner users within a precision range. The list can include the questions sent by the questioner users within the precision range. When a selection of a location marker by the user is received, the display module 94 can display the list of questions corresponding to the location marker.

The client terminal device can also include the registration/cancellation module 99, which can be used to submit a registration request to the server based on received registration information that a user has entered. The registration/cancellation module 99 can be used to submit a cancellation request to the server so that the server, after receiving the cancellation request from the user, can delete the registration information of the user from the user registration database.

The client terminal device can also include the reply module 90. After receiving a question asked by another user from the server, the reply module 90 can be used to reply to the question. After receiving a reply request from the reply module 90, the server can query for a client terminal of a questioner based on the question, and send the reply content to the client terminal of the questioner. After receiving the reply content return from the server, the reply module 90 can be used to display the reply content.

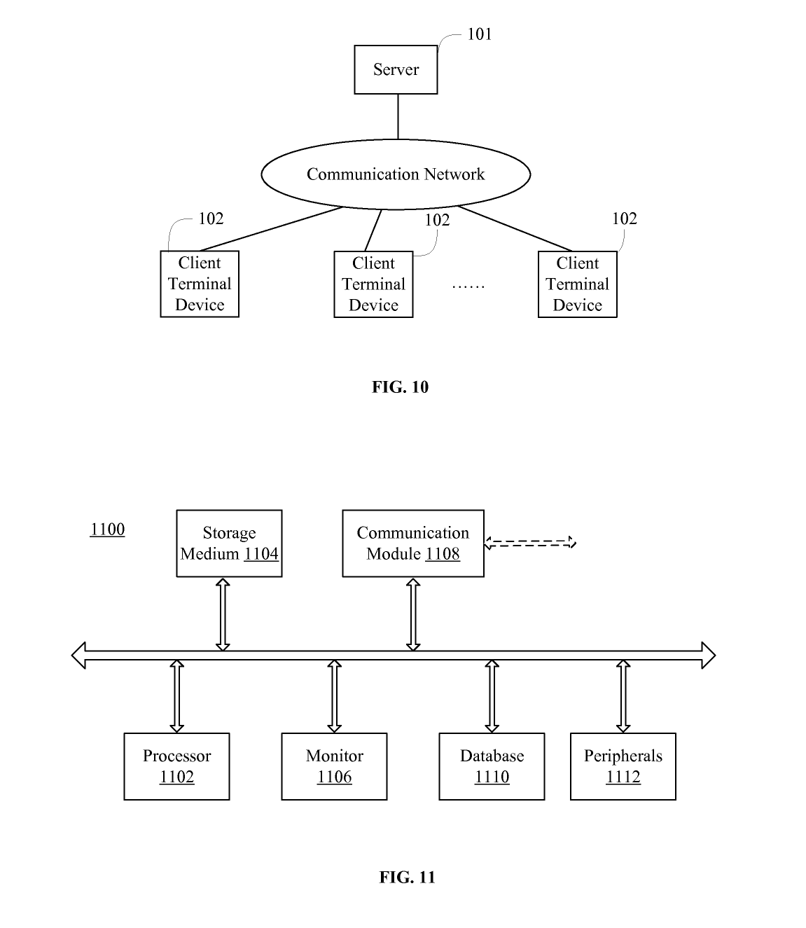

FIG. 10 depicts an exemplary environment used to implement an online Q&A system. As shown, FIG. 10 can include a server 101 (e.g., the server shown in FIG. 8), and a client terminal device 102 (e.g., the client terminal device shown in FIG. 9). The server and the client terminal device can communicate with one another via a communication network.

The client terminal device 102 can include any appropriate user terminal with wireless or wired capabilities. The client terminal device 102 can be stationary or mobile. The client terminal device 102 can include, for example, a personal computer (PC), a work station computer, a server computer, a hand-held computing device (tablet), a smart phone or mobile phone, a touch terminal, or any other user-side computing device. In various embodiments, the client terminal device 102 may include a network access device.

The server 101 may include any appropriate server computer and may be maintained and/or operated by a service operator. The client terminal device 102 may communicate with the server 101 through the communication network, such as a wireless network, the Internet, etc. Although only certain number of each of the client terminal device and server is shown in the system of FIG. 10, any number of each of the client terminal device and server may be included.

As disclosed herein, a user can be any user having a client terminal device. A user can be sometimes a questioner user, sometimes a requester user, and/or sometimes an answerer user to perform the disclosed Q&A online system.

The client terminal device 102 and the server 101 may be implemented on any appropriate computing platform. FIG. 11 shows a block diagram of an exemplary computer system 1100 capable of implementing the server 101 and/or the client terminal device 102.

As shown in FIG. 11, computer system 1100 may include a processor 1102, a storage medium 1104, a monitor 1106, a communication module 1108, a database 1110, and/or peripherals 1112. Certain devices may be omitted and other devices may be included.

Processor 1102 may include any appropriate processor or processors. Further, processor 1102 can include multiple cores for multi-thread or parallel processing. Storage medium 1104 may include memory modules, such as ROM, RAM, and flash memory modules, and mass storages, such as CD-ROM, U-disk, hard disk, etc. Storage medium 1104 may store computer programs for implementing various processes, when executed by processor 1102.

Further, peripherals 1112 may include I/O devices such as keyboard and mouse, and communication module 1108 may include network devices for establishing connections through a wireless or wired communication network. Database 1110 may include one or more databases for storing certain data and for performing certain operations on the stored data, such as database searching.

In various embodiments, the disclosed modules can be configured in one apparatus or configured in multiple apparatus as desired. The modules disclosed herein can be integrated in one module or in multiple modules. Each of the modules disclosed herein can be divided into one or more sub-modules, which can be recombined in any manner.

The disclosed embodiments can be examples only. One of ordinary skill in the art would appreciate that suitable software and/or hardware (e.g., a universal hardware platform) may be included and used to predict, manage, and execute the disclosed methods, strategies, and systems. For example, the disclosed embodiments can be implemented by hardware only, which alternatively can be implemented by software products only. The software products can be stored in a storage medium. The software products can include suitable commands to enable a client terminal device (e.g., including a mobile phone, a personal computer, a server, or a network device, etc.) to implement the disclosed embodiments.

Other applications, advantages, alternations, modifications, or equivalents to the disclosed embodiments are obvious to those skilled in the art.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

Online Q&A methods, devices, and systems are provided to solve problems that answers to a question are of low pertinence to the question, and to reduce waste of bandwidth resources. In an exemplary online Q&A method, a question request sent by a client terminal device can be received by a server. The question request can contain information about a question, an ID of a questioner user, and information about a location of the questioner user. Based on the information about the location of the questioner user and information about locations of other users, the server can determine other online users from the other users within a set distance range from the location of the questioner user. The server can then send the received information about the question to client terminal devices of the other online users within the set distance range from the location of the questioner user.

That is, when a server receives a question request sent by a client terminal device, based on information about a location of a questioner user and information about locations of other users, the server can determine other online users among the other users within a set distance range from the location of the questioner user and send information about a question contained in the question request to client terminal devices of the other online users. This can improve the pertinence of replies to the question and the effectiveness of the replies from the other online users to the questioner user. This can also allow the questioner users to timely and accurately solve their problems.

What is claimed is:

1. An online Q&A method, comprising:
receiving, by a server, a question request sent by a client terminal device, the question request containing information about a question, an ID of a questioner user, and information about a location of the questioner user;
determining, by the server, based on the information about the location of the questioner user and information about locations of other users, other online users from the other users within a set distance range from the location of the questioner user; and
sending, by the server, the received information about the question to client terminal devices of the other online users within the set distance range from the location of the questioner user.

2. The method of claim 1 further including, after the receiving by the server the question request sent by the client terminal device,
updating, by the server, based on the ID of the questioner user and the information about the location of the questioner user that are contained in the question request, the information about the location of the questioner user that has been recorded by the server.

3. The method of claim 1, wherein, after the server receiving the question request sent by the client terminal device, the server records content and an ID of the information about the question, and a corresponding relationship between the ID of the questioner user and the information about the question, the method further including:
receiving, by the server, a reply request from a client terminal device, the reply request containing information about a reply, the ID of the information about the question that the reply is directed to, and an ID of an answerer user;
querying, by the server, based on the ID of the information about the question, for the ID of the questioner user that has been recorded by the server; and
sending, by the server, based on the ID of the questioner user, the information about the reply to the client terminal device corresponding to the ID of the questioner user.

4. The method of claim 3, wherein, after receiving the reply request, the server also records content and an ID of the information about the reply, the ID of the information about the question that the reply is directed to, and a corresponding relationship among the ID of the questioner user, the information about the question, and the information about the reply, the method further including:
querying, by the server, based on the ID of the information about the question that the reply is directed to, for IDs of other answerer users corresponding to the ID of the information about the question that have been recorded by the server, and
sending, by the server, the information about the reply to corresponding client terminal devices based on the queried IDs of the other answerer users.

5. The method of claim 1, further including:
receiving, by the server, a refreshing request or a query request sent by a client terminal device of a requester user, the refreshing request or query request including an ID of the requester user;
determining, by the server, based on information about a location of the requester user and information about locations of other users, other online users from the other users within a set distance range from the location of the requester user, and querying, by the server, for information about questions sent by the other online users; and
returning, by the server, the information about the questions sent by the other online users and information about locations of questioner users to the client terminal device of the requester user.

6. The method of claim 5, further including, after the client terminal device of the requester user receiving the information about questions sent by the other online users and the information about the locations of the questioner users:
deleting, by the client terminal device of the requester user, contents and IDs of information about questions and information about locations of questioner users from a local cache;
caching, by the client terminal device of the requester user, contents and IDs of the received information about questions and the information about locations of the questioner users;
identifying, by the client terminal device of the requester user, a location of each of the questioner users cached in the local cache on an electronic map of the client terminal device of the requester user by using a location marker;
generating, by the client terminal device of the requester user, based on a precision level of the location marker on the electronic map, a listing of questions asked by questioner users within a range of the precision, the listing containing information about questions sent by the questioner users within the range of the precision; and
displaying, by the client terminal device of the requester user, the listing of questions corresponding to the location marker after the location marker selected by the requester user is received by the client terminal device of the requester user.

7. The method of claim 1, further including:
sending by the client terminal device to the server a login request, before sending the question request by the client terminal device to the server, the login request containing information about a user account of a login user and information about a location of the login user;
performing, by the server, verification of the information about the user account of the login user, and after the verification passes, storing the information about the location of the login user by the server;
determining, by the server, based on the information about the location of the login user and information about locations of other users, other online users within a set distance range from the location of the login user;
querying, by the server, for information about questions sent by the other online users that has been recorded by the server; and
sending, by the server, the information about the questions sent by the other online users and information about locations of corresponding questioner users to the client terminal device of the login user for displaying.

8. The method of claim 7, further including:
caching contents and IDs of the received information about the questions and the information about the locations of the questioner users in a local cache, after the client terminal device of the login user receives the information about the questions sent by the other online users and the information about the locations of the corresponding questioner users from the server;
identifying a location of each of the questioner users cached in the local cache on an electronic map of the client terminal device of the login user by using a location marker;
generating based on a precision level of the location marker on the electronic map, a listing of questions asked by questioner users within a range of the precision, the listing including information about questions sent by the questioner users within the range of the precision; and
displaying the listing of questions corresponding to the location marker after the location marker selected by the login user is received by the client terminal device of the login user.

9. A server used in an online Q&A system, comprising:
a receiving module configured to receive a question request sent by a client terminal device, the question request containing information about a question, an ID of a questioner user, and information about a location of the questioner user;
a sending module; and
a question processing module configured to determine, based on the information about the location of the questioner user and information about locations of other users, other online users from the other users within a set distance range from the location of the questioner user, and configured to instruct the sending module to send the information about the question to client terminal devices of the other online users that are within the set distance range from the location of the questioner user, such that the sending module sends the information about the question according to the instructing from the question processing module.

10. The server of claim 9, wherein the question processing module is further configured to update the information about the location of the questioner user that the server has recorded, based on the ID of the questioner user and the information about the location of the questioner user that are contained in the question request.

11. The server of claim 9, further including a reply processing module, wherein:
the question processing module is further configured to record content and an ID of the information about the question contained in the question request and a corresponding relationship between the ID of the questioner user and the information about the question;
the receiving module is further configured to receive a reply request from a client terminal device, the reply request containing information about a reply, the ID of the information about the question that the reply is directed to, and an ID of an answerer user;
the reply processing module is configured to query for the ID of the questioner user that has been recorded by the server, based on the ID of the information about the question; and to instruct the sending module to send the information about the reply to the client terminal device corresponding to the ID of the questioner user; and
the sending module is further configured to send the information about the reply according to an instruction from the reply processing module.

12. The server of claim 11, wherein the reply processing module is further configured:
to record, after receiving a reply request, content and an ID of the information about the reply, the ID of the information about the question that the reply is directed to, and a corresponding relationship among the ID of the questioner user, the information about the question, and the information about the reply;
to query, based on the ID of the information about the question that the reply is directed to, for IDs of other answerer users corresponding to the ID of the information about the question that have been recorded; and
to instruct the sending module to send the information about the reply to corresponding client terminal devices based on the queried IDs of the other answerer users.

13. A client terminal device used in an online Q&A system, comprising:
a question module configured to generate a question request based on entered information about a question and obtained information about a location of a questioner user, the question request containing the information about the question, an ID of the questioner user, and the information about the location of the questioner user;
a sending module configured to send the question request generated by the question module to a server;
a receiving module configured to receive returned information of the question request from the server with respect to other users, wherein the server determines, based on the information about the location of the questioner user and information about locations of other users, other online users from the other users within a set distance range from the location of the questioner user; and sends the received information about the question sent by the questioner user to client terminal devices of the other online users within the set distance range from the location of the questioner user; and
a display module configured to display the information received by the receiving module.

14. The device of claim 13, further including a refreshing module and a cache module, wherein:
the refreshing module is configured: to send to the server a refreshing request, the refreshing request containing an ID of a refreshing requester user; to empty the cache module after receiving information about refreshed data returned from the server; and to store the information about the refreshed data to the cache module, wherein the server determines, based on information about a location of the refreshing requester user and information about locations of other users, other online users from the other users within a set distance range from the location of the refreshing requester user, and queries for information about questions sent by the other online users; and returns the information about the questions sent by the other online users and information about locations of questioner users to a client terminal device of the refreshing requester user;
the cache module is configured to cache contents and IDs of the received information about questions and the information about locations of the questioner users; and
the display module is configured to identify on an electronic map of the client terminal device a location of each of the questioner users cached in the cache module by using a location marker; to generate, based on a precision level of the location marker on the electronic map, a listing of questions asked by questioner users within a range of the precision, the listing containing information about questions sent by the questioner users within the range of the precision; and to display the listing of questions corresponding to the location marker after the location marker selected by the refreshing requester user is received.

15. The device of claim 13, further including a login module, wherein:
the login module is configured to send a login request via the sending module to the server and receive information returned from the server, the login request containing information about a user account of a login user and information about a location of the login user, wherein the server determines, based on the information about the location of the login user and information about locations of other users, other online users within a set distance range from the location of the login user, queries for information about questions sent by the other online users that has been recorded by the server, and sends the information about the questions sent by the other online users and information about locations of corresponding questioner users to the client terminal device of the login user; and
the display module is configured to identify on an electronic map of the client terminal device a location of each of the questioner users cached in the cache module by using a location marker; to generate, based on a precision level of the location marker on the electronic map, a listing of questions asked by questioner users within a range of the precision, the listing containing information about questions sent by the questioner users within a range of the precision; and to display the listing of questions corresponding to the location marker after the location marker selected by the login user is received.
